(19) United States
(12) Patent Application Publication
(10) Pub. No.: US 2024/0095448 A1
(43) Pub. Date: Mar. 21, 2024

(54) AUTOMATIC GUIDANCE TO INTERACTIVE ENTITY MATCHING NATURAL LANGUAGE INPUT

(71) Applicant: ServiceNow, Inc., Santa Clara, CA (US)

(72) Inventor: Darius Koohmarey, San Diego, CA (US)

(21) Appl. No.: 17/949,944

(22) Filed: Sep. 21, 2022

(51) Int. Cl. G06F 40/279; G06F 16/954; G06F 40/247

(52) U.S. Cl. CPC G06F 40/279; G06F 16/954; G06F 40/247

(57) ABSTRACT

A natural language input is received. The natural language input is provided to a machine learning model to identify a content page associated with an intent of the natural language input. The content page is dynamically analyzed to determine interactive entities of the content page. Among the interactive entities of the content page, a matching interactive entity corresponding to the natural language input is identified, and an indication of the matching interactive entity is provided.

### BACKGROUND OF THE INVENTION

Software services improve the efficiency and accuracy for certain tasks and can sometimes even automate tasks that were previously performed manually. A common approach for interfacing with a software service is through a graphical user interface such as one exposed through a web browser. Using a graphical user interface, a user can view and interact with different portions or components of the user interface including different menus and buttons. In many scenarios, interacting with different user interface components allows the user to access additional user interface components such as additional user interface screens and menus. The newly accessed user interface components can correspondingly expose additional functionality. One common design technique is to initially expose general or high-level functionality to the user and then, based on the user's selection, provide more detailed or specific functionality through additional user interface components.

### BRIEF DESCRIPTION OF THE DRAWINGS

Various embodiments of the invention are disclosed in the following detailed description and the accompanying drawings.

FIG. 1 is a block diagram illustrating an example of a network environment for automatically guiding a user to an interactive user interface component using natural language input.

FIG. 2 is a flow chart illustrating an embodiment of a process for automatically guiding a user to an interactive user interface component using natural language input.

FIG. 3 is a flow chart illustrating an embodiment of a process for identifying a content page associated with a natural language input.

FIG. 4 is a flow chart illustrating an embodiment of a process for identifying a matching entity within a content page that is associated with a natural language input.

FIG. 5 is a flow chart illustrating an embodiment of a process for providing an indication of a matching entity within a content page that is associated with a natural language input.

FIG. 6 is a diagram illustrating an embodiment of a virtual agent user interface for providing natural language input.

FIG. 7 is a diagram illustrating an embodiment of an example content page of an application service accessible via an automatic guidance service.

FIG. 8 is a diagram illustrating an embodiment of a virtual agent user interface for providing natural language input.

FIG. 9 is a diagram illustrating an embodiment of an example content page of an application service accessible via an automatic guidance service.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Automatic guidance for interactive user interface components using natural language input is disclosed. An application service with an interactive user interface can include multiple interactive user interface components and multiple levels of user interfaces. The disclosed system and techniques provide automatic guidance for these user interfaces and corresponding components including the ability to guide the user to the correct user interface component entity based on the user's natural language input. For example, a user can provide a natural language input such as a chat message to a chat bot or virtual agent or to another input field, such as a global search bar in an application header. The natural language input is analyzed to determine the meaning behind the user's request. Based on the analysis performed, the user is automatically guided to a user interface component entity on a content page of the application service that matches the user's request. The automatic guidance process highlights and/or focuses on a button or another user interface component of the matching entity that is required for performing the user's desired result. For example, the user may input the request “How do I edit the credit card on file?” and is automatically guided to the Account Management content page and the subsection for Payment info. A button labeled “Add info” that is part of the Payment info subsection is highlighted to provide the user with guidance on updating the user's credit card information. In various embodiments, the corresponding presentation style of the matching button element is dynamically modified as part of a guidance presentation. By guiding the user to the specific content page and subsection, the guidance presentation provides user training in response to the current request while also teaching the user how to address future related requests.

In some embodiments, a natural language input is received. For example, a user provides natural language input such as a chat or voice request. The natural language input is provided to a machine learning model to identify a content page associated with an intent of the natural language input. In various embodiments, each potential intent of a user is configured to map to a specific content page of the application service. When provided with natural language input, such as a chat or voice request, the natural language input is analyzed using one or more trained machine learning models to predict a corresponding intent of the natural language input. Using the configured intent to content page mappings, the predicted intent is matched to identify a content page of the application service.

In some embodiments, the content page is dynamically analyzed to determine interactive entities of the content page. For example, the automatic guidance service then dynamically analyzes the content page to determine a set of entities within the content page. In some embodiments, the entities are user interface components of the content page and can correspond to subsections of the content page. The entities can be determined by analyzing the structure of the content page. For example, the structure of the content page can be parsed to determine different HTML (or similar) tags or markup language tags/elements that correspond to different levels of hierarchy within the page. Example HTML tags of interest include header tags such as <h1>, <h2>, and <h3> elements as well as <button> classes. Based on the dynamic analysis performed, the entities of the content page are identified along with their corresponding context and interactive components, such as buttons. In some embodiments, the contents of each interactive user interface component entity are analyzed for synonyms to determine their respective contexts. For example, the words “credit card” included within an entity labeled as “Payment info” can be associated with the “Payment info” entity to create a more complete context for the entity and to differentiate it from other entities on the same content page. Each entity can be further analyzed to determine interactive components, such as buttons. For example, a button labeled “Add info” can be identified for a “Payment info” entity that allows the user to modify the credit card payment information.

In some embodiments, among the interactive entities of the content page, a matching interactive entity corresponding to the natural language input is identified. The determined context for each interactive entity for the content page can be used to match the natural language input to one of the interactive entities. For example, the “Payment info” entity on an Account Management content page can be identified as the matching entity when a user requests to modify their credit card information. For the identified matching entity, an indication is provided. The indication can be a change in the presentation of a corresponding interactive user interface component of the matching entity, such as flashing or highlighting a button to invoke the matching entity, or another guidance related indication. For example, a button labeled “Add info” that is part of a “Payment info” entity can be highlighted and brought into focus for the user. In some embodiments, in the event the relevant interactive entity was referenced by the user in the original natural language input, a corresponding input for the interactive entity can be extracted if one exists. The provided input can be automatically inserted into the input field value of the interactive entity in the content page using a named entity recognition model.

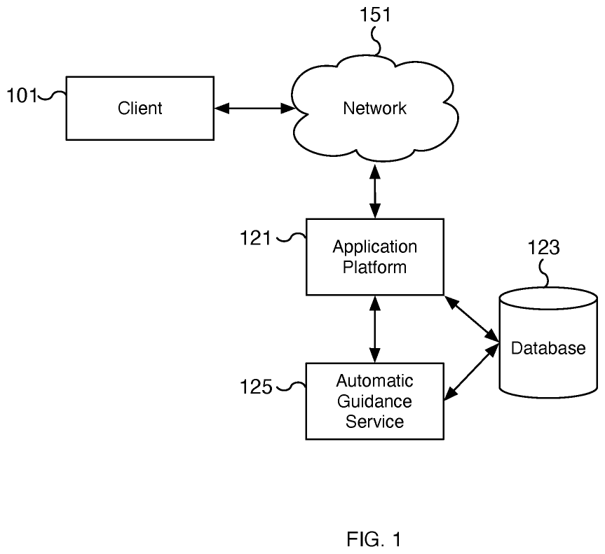

FIG. 1 is a block diagram illustrating an example of a network environment for automatically guiding a user to an interactive user interface component using natural language input. In the example shown, client 101 accesses cloud-based application platform 121 via network 151. Network 151 can be a public or private network. In some embodiments, network 151 is a public network such as the Internet. Application platform 121 hosts cloud application services that include multiple content pages. Application platform 121 provides an automatic guidance service for navigating its content pages via automatic guidance service 125. The guidance service provided by automatic guidance service 125 allows client 101 to request guidance for navigating the content pages of application platform 121 by providing natural language input. Both application platform 121 and automatic guidance service 125 can utilize database 123 for storing and/or retrieving data including configuration data for the automatic guidance of content pages of application platform 121.

In some embodiments, client 101 is a network client for accessing content pages hosted by application platform 121. For example, using a web browser client, client 101 can access web pages hosted by an application service of application platform 121. In some embodiments, client 101 is a desktop computer, a laptop, a mobile device, a tablet, a kiosk, a voice assistant, a wearable device, or another network computing device. In various embodiments, client 101 can access a guidance service provided by automatic guidance service 125 via application platform 121 that helps client 101 navigate the different content pages hosted on application platform 121. For example, client 101 can provide a request using natural language input and will be guided to the appropriate content page and entity within the content page. Moreover, interactive elements such as a button of the identified entity of the content page can be highlighted as part of the guidance process.

In some embodiments, application platform 121 offers cloud-based application services via multiple content pages. Each of the content pages is associated with a specific user intent and can include multiple subsections. For example, an account management content page can include subsections for managing or accessing details related to the user's subscription, usage of services, payment information, billing owner, latest invoice, and contacting support. Each subsection can also include interactive elements such as buttons to access the corresponding subsections. In various embodiments, the different subsections of the content page are different user interface component entities and are described in the content page using similar HTML or language markup tags/elements. For example, each subsection can exist in the content page source at the same level in the content page hierarchy with the account management main section existing at a higher level in the hierarchy.

In some embodiments, automatic guidance service 125 is a guidance service that automatically provides navigational guidance for content pages. For example, when configured for an application service, such as an application service hosted by application platform 121, automatic guidance service 125 provides a guidance service to users of application platform 121 that helps users navigate to the proper content page and entity within the content page. In some embodiments, the automatic guidance service is accessible via a chat bot or virtual agent service of automatic guidance service 125. For example, a client can interface via a chat dialog embedded in the webpages hosted by application platform 121 by relying on automatic guidance service 125 for at least portions of the virtual agent functionality. As another example, the guidance service includes a voice-based agent capable of processing natural language input provided as voice input. In various embodiments, automatic guidance service 125 utilizes machine learning techniques to predict an intent for natural language input provided by a client such as client 101. Based on the predicted intent, a matching content page is determined and analyzed for entities. Using the provided natural language input, the matching entity within the matching content page is identified. For example, the natural language input can be matched based on the context of each entity. The identified entity is further analyzed to identify interactive components of the entity, such as buttons, and one or more of the identified interactive components of the entity are selected to highlight for the client.

In some embodiments, database 123 is utilized by application platform 121 and/or automatic guidance service 125 as a data store for storing and/or retrieving data including configuration data, training data, trained machine learning models, content page sources, etc. For example, as an initialization step, configuration data can be created and stored on database 123. In some embodiments, each potential intent of a user is mapped to one specific content page hosted by application platform 121. Similarly, utterances corresponding to natural language input are configured and mapped to the potential intents for training one or more machine learning models to predict an intent based on natural langue input. In some embodiments, the various configuration data and the trained machine learning models are stored in a database such as database 123.

In the example shown, portions of the communication path between the components are shown. Other communication paths may exist, and the example of FIG. 1 has been simplified to illustrate the example clearly. Although single instances of some components have been shown to simplify the diagram, additional instances of any of the components shown in FIG. 1 may exist. For example, automatic guidance service 125 may include one or more of automatic guidance, virtual agent application, and machine learning training and/or inference servers. Additionally, automatic guidance service 125 can include components not shown but described herein such as a live agent for processing a chat conversation, a management interface for configuring the automatic guidance service and/or virtual agents, and a Natural Language Understanding (NLU) training engine for training utterances to predict matching intents. Furthermore, client 101 is just one example of a potential client to application platform 121. Similarly, application platform 121 may include one or more application servers and database 123 may include one or more database servers. In some embodiments, database 123 may not be directly connected to application platform 121 and/or automatic guidance service 125. For example, database 123 and its components may be replicated and/or distributed across multiple servers and/or components. In some embodiments, components not shown in FIG. 1 may also exist.

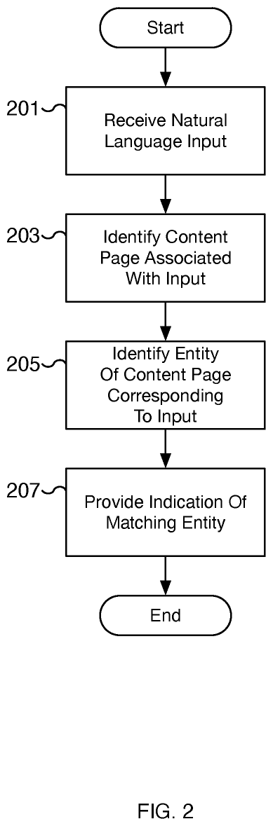

FIG. 2 is a flow chart illustrating an embodiment of a process for automatically guiding a user to an interactive user interface component using natural language input. For example, a client accessing an application service can provide a natural language input request via a virtual agent, search bar, or another appropriate interface. In response to the request, the client is guided to the correct content page and entity within the content page of the application service. In some embodiments, the process of FIG. 2 is performed by an automatic guidance service embedded in content pages of an application service hosted by an application platform to help a client navigate the hosted content pages. In some embodiments, the automatic guidance service is automatic guidance service 125 of FIG. 1, the application platform is application platform 121 of FIG. 1, and the client is client 101 of FIG. 1.

At 201, natural language input is received. For example, a client provides input as natural language input forming a request for guidance related to functionality provided by an application platform. The input can be provided in text form, such as via a text-based message to a virtual agent or chat bot. In some embodiments, the input is provided in an audio format such as by speaking to a voice assistant.

At 203, a content page associated with the natural language input is identified. For example, the natural language input received at 201 is analyzed to determine a matching content page hosted by the application platform. In some embodiments, the identified content page is determined by utilizing one or more trained machine learning models and deep learning techniques. For example, a machine learning model can be trained using different utterances to predict an intent associated with the provided input, and each potential intent can be mapped to a specific content page of the application server. By performing inference on the natural language input, an intent can be predicted and mapped to identify the specific content page associated with the natural language input.

At 205, an entity of the content page corresponding to the natural language input is identified. For example, the content page is analyzed to determine the component entities of the content page. Each entity may correspond to a subsection of the content page. In some embodiments, the entities are associated with a particular HTML or formatting markup language tag, and the corresponding structure is used to identify the different entities of the content page. The identified entities are further analyzed to determine their respective contexts. In some embodiments, the context of each entity is determined by identifying synonyms associated with each entity to form canonical meaning of the entity. Based on their determined contexts, an entity is identified that matches the natural language input.

At 207, an indication of the matching entity is provided. For example, an interactive user interface component, such as a button of the matching entity, is highlighted and/or brought into focus. In some embodiments, the source code of the matching entity is analyzed to identify interactive elements, such as buttons and/or links, and an indication is provided for one or more of the identified elements. For example, a highlight presentation indication can be provided by modifying the presentation style associated with an interactive user interface component of the identified matching entity. In some embodiments, the indication is provided by modifying a corresponding cascading style sheet (CSS) and/or property/element of the CSS associated with the interactive user interface component of the identified matching entity.

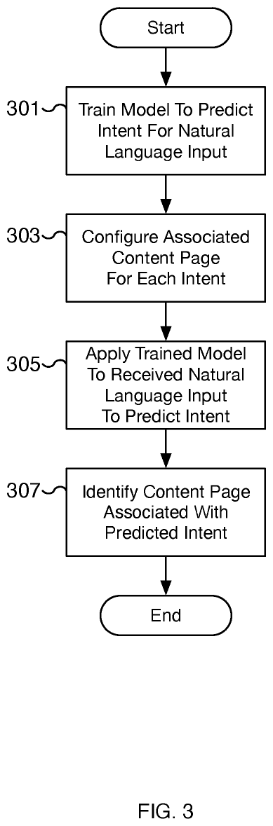

FIG. 3 is a flow chart illustrating an embodiment of a process for identifying a content page associated with a natural language input. For example, a client provides a natural language input request that is analyzed to identify a matching content page of an application service. In various embodiments, the natural language input is first analyzed to determine an intent, and the intent is then matched to a configured content page of the application service. In some embodiments, the process of FIG. 3 is performed by an automatic guidance service at 203 of FIG. 2 as part of the process for guiding a user to an interactive user interface component of the content page. In some embodiments, the automatic guidance service is automatic guidance service 125 of FIG. 1, the application platform hosting the application service is application platform 121 of FIG. 1, and the client is client 101 of FIG. 1.

At 301, a model is trained to predict an intent for natural language input. For example, for each potential intent, one or more utterances are configured that correspond to the intent. The configured utterances are sample or example natural language inputs that match the corresponding intent. In some embodiments, the utterances are configured using text strings, voice records, or another format for providing natural language input. Once configured, the provided utterances are used to build and train intents. In some embodiments, the intents correspond to actions that the client wants to perform and/or are responsibilities that are handled by the application service. In various embodiments, one or more machine learning training servers are used to train one or more machine learning models for predicting intents. The trained models can be stored on a data store such as database 123 of FIG. 1.

At 303, an associated content page for each intent is configured. For example, the application service hosts a set of content pages, each associated with some functionality provided by the application service. At 303, for each potential intent, at most one content page is associated with it. In various embodiments, the entity to content page mapping is configured and stored for later matching a predicted intent to a specific content page of the application service. The entity to content page mapping can be stored on a data store such as database 123 of FIG. 1 for use when matching predicted intents to content pages.

At 305, the trained model is applied to received natural language input to predict an intent. For example, a client provides natural language input as part of submitting a request. The natural language input can be received via a virtual agent interface used by the client. At 305, the machine learning model trained at 301 is applied to the received natural language input to predict an intent. In some embodiments, each predicted intent has an associated confidence score and a minimum configured score is required before the user's natural language input is used for automatic guidance to a content page and processing can continue to step 307. For example, in the event the confidence score does not exceed a minimum required confidence score, the client may be asked to rephrase the request and/or provide additional information.

At 307, the content page associated with the predicted intent is identified. Using the entity to content page mapping configured at 303, the intent predicted at 305 is used to identify the matching content page. In various embodiments, each predicted intent maps to a unique content page of the application service. Once the matching content page is determined, the identified content page can be used for further processing including automatically guiding and/or navigating the user to the identified content page and contents within the identified content page.

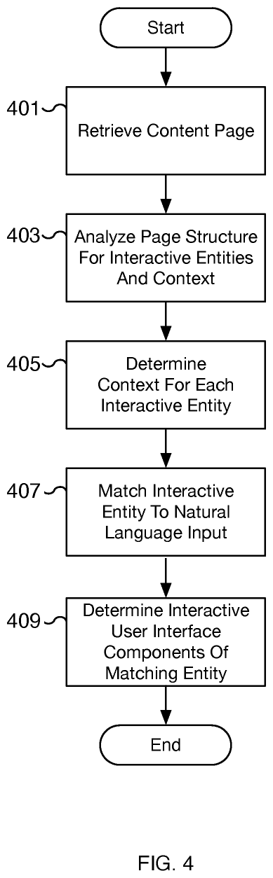

FIG. 4 is a flow chart illustrating an embodiment of a process for identifying a matching entity within a content page that is associated with a natural language input. For example, a client provides a natural language input request that is analyzed to identify a matching content page of an application service. Once the content page is identified, based on the provided natural language input, an interactive entity within the content page is also identified that corresponds to the user's natural language input request. In some embodiments, the process of FIG. 4 is performed by an automatic guidance service at 205 of FIG. 2 as part of the process for guiding a user to an interactive user interface component of the content page hosted by an application service. In some embodiments, the automatic guidance service is automatic guidance service 125 of FIG. 1, the application platform hosting the application service is application platform 121 of FIG. 1, and the client is client 101 of FIG. 1.

At 401, a content page is retrieved. For example, a content page is previously identified as matching the provided natural language input. The identified content page is retrieved at 401, for example, by pulling the content base using a page, HTTP, or similar request. In some embodiments, a cached version of the content page may exist and can be used if the cached version has not expired. In various embodiments, the retrieved content page is an HTTP formatted webpage and can reference one or more cascading style sheets.

At 403, the content page structure is analyzed for interactive entities. For example, the received page is parsed to determine its page structure based on its HTML elements. Using the determined page structure, interactive entities within the content page are identified. In some embodiments, the source code of the content page includes structural markers, such as HTML tags or elements, used to denote different portions of the content page. For example, each interactive entity of a content page can correspond to a subsection of the content page and the different subsections can exist in the content page source at the same level in the content page hierarchy. The different interactive entities can be assigned to the same HTML tag, such as the same heading tag (e.g., <h2>) or another appropriate HTML tag or element. In contrast, the main section of the content page can be assigned to a different HTML tag, such as an <h1> or heading 1 HTML tag. Based on the page structure, the main section is associated with a different level in page hierarchy of elements. Although header tags are used as examples, other HTML tags or elements can be used to distinguish the interactive entities and their corresponding sections. In some embodiments, the analysis includes identifying a corresponding document object model node of the content page associated with each of the interactive entities of the content page. By analyzing the content page, the different subsections of the content page can be identified along with their corresponding document object model nodes. In some embodiments, the corresponding style elements of the entities are also analyzed. For example, the style and/or presentation style elements associated with the content page, including associated cascading style sheets, can be analyzed to identify the interactive entities as well as to determine how to modify their visual presentation.

At 405, the context for each interactive entity is determined. For example, a context for each identified entity is determined and used to describe and distinguish the entities from one another. In various embodiments, the contents of each entity such as their descriptions, contents, and other included text are analyzed to determine the context for the corresponding entity. In some embodiments, the contents include the text within the entity's corresponding portion of the content page. For example, a “Payment info” entity can include the text “No credit cards added.” As another example, an entity for downloading a mobile app can include a link to a specific app store or version of an app store. As a further example, a profile page can include a subsection and/or field for updating the user's phone number for receiving notifications and includes descriptive words such as “notification,” “phone number,” and “update.” In some embodiments, text including links and descriptions of the links is extracted from the entities and their contents to create a list of synonyms that describe an entity. For example, a “Payment info” entity that includes the text “No credit cards added” can include the synonyms “payment” and “credit card.” In various embodiments, a list of synonyms is built for each interactive entity. In some embodiments, external sources can be used to add additional synonyms if needed. For example, an external source can be used to add the words: “debit card” and “checking account” to the context for the “Payment info” entity. Once the context is generated, the context for the different entities can be used to determine which entity best matches the client's provided natural language input.

At 407, an interactive entity is matched to the natural language input. Using the context created for the interactive entities at 405, the client's provided natural language input is matched to one of the interactive entities. In various embodiments, the provided natural language input is analyzed and compared to a list of synonyms created for an entity's context. For example, the natural language input “how do i edit the credit card on file” is analyzed and compared to the contexts created for the entities. A “Payment info” entity with the synonyms “payment” and “credit card” is determined to best match this provided natural language input. Even though the entity heading “Payment info” does not capture the term “credit card,” the context of the entity does include the term “credit card,” which is used to help match the natural language input. In various embodiments, different analysis techniques can be used to match the natural language input to the different entity contexts and a confidence or difference score is determined for each entity. Based on the determined scores, the best matching entity is identified as matching the natural language input. In some embodiments, a minimum confidence score is required to match an entity.

At 409, interactive user interface components of the matching entity are determined. For example, once an entity is identified as matching the provided natural language input, the entity is further analyzed to identify interactive user interface components such as buttons or links to use to access the entity. For example, a “Payment info” entity can include an “Add info” button that reveals additional user interface screens for modifying the payment information. The “Add info” button is identified as an interactive user interface component of the entity. In some embodiments, one or more of the determined interactive user interface components are used to highlight the matching entity. For example, a button of the matching entity can be brought into focus as part of the automatic guidance service. In particular embodiments, the presentation style of an interactive user interface component of the matching entity is modified to change its visual appearance. The presentation style of the matching entity is modified at least in part to attract the client's attention to the action(s) required to complete their intended task using the application service.

In some embodiments, in the event the relevant interactive entity was referenced by the user in the original natural language input, a corresponding input for the interactive entity can be extracted if one exists. The provided input can be automatically inserted into an input field value of the interactive entity in the content page using a named entity recognition model. For example, an identified interactive user interface component of the matching entity can include an input field, and the extracted client input is automatically inserted as the input field value of the interactive user interface component.

In various embodiments, with a combination of understanding the client's intent, which is mapped to a content page, along with an understanding of the specific entity, which can be mapped to a specific input field, button or action, an entity value can be extracted from the natural language input and inserted into the corresponding input form. For example, if a client provides the natural language input “how do i update my phone number to 4085551234”, then the intent is matched to the corresponding content page and the client is guided to the corresponding “Profile” content page to edit their contact information. As a result of an added entity that is recognized through named entity recognition (the phone number), the extracted value can be inserted into the phone number field. In some embodiments, the correct field is identified by matching the named entity type with the input field data type (e.g., the phone number field), and a phrase of the original intent phrase (e.g., phone number). For example, the interactive “Phone” field of an “Edit Profile” entity can be filled with the provided input (e.g., “4085551234”) based on the corresponding detected input of the natural language input. In some embodiments, the interactive “Phone” field is further highlighted to draw the client's attention to the completed/proposed action automatically performed in response to the client's request. For example, using cascading style sheet (CSS) styling, the field can be highlighted to ensure that the client has an opportunity to review the prefilled values for accuracy and to perform a final save action on the form.

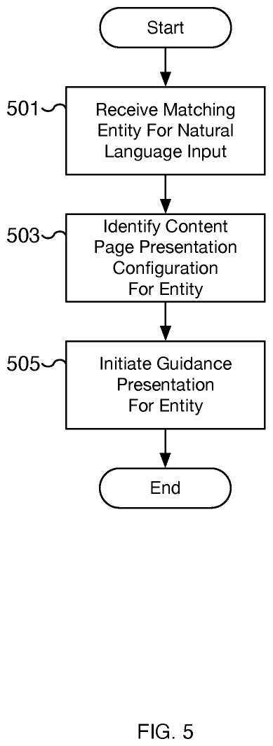

FIG. 5 is a flow chart illustrating an embodiment of a process for providing an indication of a matching entity within a content page that is associated with a natural language input. For example, a client provides a natural language input request that is analyzed to identify a matching content page of an application service. Based on the provided natural language input, an interactive entity within the content page is also identified. An indication of the identified matching interactive entity is provided, such as a specialized guidance presentation to direct the client's attention to the identified entity. In some embodiments, the provided indication involves highlighting, flashing, and/or another method of changing the visual appearance of the identified matching interactive entity. In some embodiments, the process of FIG. 5 is performed by an automatic guidance service at 207 of FIG. 2 as part of the process for guiding a user to an interactive user interface component of the content page hosted by an application service. In some embodiments, the automatic guidance service is automatic guidance service 125 of FIG. 1, the application platform hosting the application service is application platform 121 of FIG. 1, and the client is client 101 of FIG. 1.

At 501, a matching entity for the natural language input is received. For example, the entity of a content page that best matches the natural language input is received. In some embodiments, the entity is identified by its HTML, tag and/or elements in the content page. For example, the content page is analyzed to identify the document object model node(s) associated with the matching entity. In some embodiments, one or more of the determined interactive user interface components or the matching entity are also received.

At 503, the content page presentation configuration for the entity is identified. For example, presentation formats for the matching entity and its interactive user interface components are identified. In some embodiments, the presentation formats are style elements described in a presentation format such as via a cascading style sheet. In various embodiments, the presentation style and/or visual hooks for the entity and its appropriate components are identified. By identifying the visual hooks and formatting configuration elements, the presentation of the entity can be modified at 505 to guide the client to the matching entity within the content page as part of the automatic guidance service.

At 505, a guidance presentation for the entity is initiated. For example, a presentation for guiding the client to the matching entity is initiated. In some embodiments, the guidance presentation involves visually modifying the matching entity and its interactive user interface components. For example, an interactive user interface component of the matching entity such as a button or download icon can be highlighted and/or brought into focus. In some embodiments, the entity and its interactive user interface components are flashed, highlighted, outlined, animated, and/or modified to emphasize their location and functionality on the content page. In some embodiments, the guidance presentation includes modifying an associated cascading style sheet and/or cascading style sheet elements.

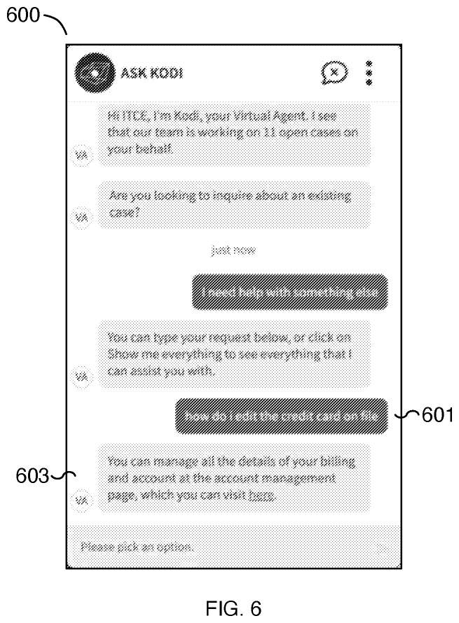

FIG. 6 is a diagram illustrating an embodiment of a virtual agent user interface for providing natural language input. Using the processes of FIGS. 2-5, a client is presented with virtual agent user interface 600 and in response to a provided natural language input client request, the client can be automatically guided to a content page and corresponding entity of the content page. In some embodiments, the virtual agent user interface is provided to a client by an application service utilizing an automatic guidance service. For example, the automatic guidance service implements the virtual agent as part of its automatic guidance service. In some embodiments, the automatic guidance service is automatic guidance service 125 of FIG. 1, the application platform hosting the application service is application platform 121 of FIG. 1, and the client is client 101 of FIG. 1.

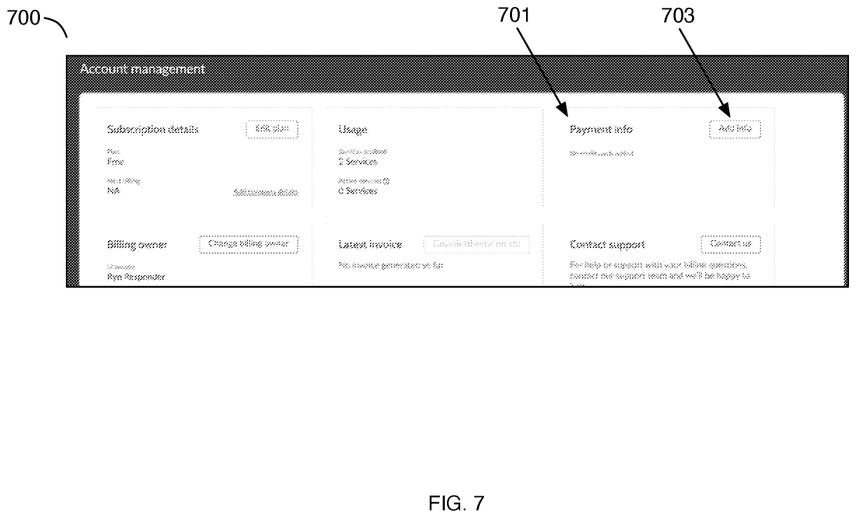

In the example shown, virtual agent user interface 600 is the user interface for a virtual agent. Using the virtual agent, a client can provide natural language input including requests for navigating the content pages of the application service. As shown in FIG. 6, virtual agent user interface 600 includes natural language input request 601 and automatic guidance service response 603. Natural language input request 601 includes the request “how do i edit the credit card on file” as provided by the client without punctuation and capitalization. In response, the automatic guidance service automatically directs the client to the corresponding content page and entity within the content page that is hosted by the application service. In addition, the automatic guidance service provides a text-based response via the virtual agent including the response “You can manage all the details of your billing and account at the account management page, which you can visit here.” The last word “here” in the response includes a direct link to the identified content page. In various embodiments, the identified content page is shown in FIG. 7.

FIG. 7 is a diagram illustrating an embodiment of an example content page of an application service accessible via an automatic guidance service. Content page 700 is hosted by an application service and includes multiple subsections including labeled interactive entity 701 and interactive user interface component 703. In response to natural language input request 601 of FIG. 6, the client is automatically directed and/or guided to content page 700 and specifically to interactive entity 701 and interactive user interface component 703 within content page 700. For example, interactive user interface component 703 of interactive entity 701 is highlighted and/or brought into focus for the client in response to the client's natural language input request. In some embodiments, the automatic guidance service is automatic guidance service 125 of FIG. 1, content page 700 is hosted on application platform 121 of FIG. 1, and the client is client 101 of FIG. 1.

In the example shown, content page 700 corresponds to the “Account management” content page and includes six subsections: “Subscription details,” “Usage,” “Payment Info,” “Billing owner,” “Latest invoice,” and “Contact support.” The six subsections are interactive user interface component entities and relate to the user's subscription, usage of services, payment information, billing owner, latest invoice, and contacting support, respectively. In some embodiments, the source code of content page 700 associates the <h1> (or heading 1) HTML tag with the “Account management” heading and each of the interactive entities with the same tag as each other but different than the one for “Account management.” For example, the interactive entities can each be associated with the <h2> (or heading 2) HTML tag.

As shown in FIG. 7, interactive entity 701 corresponds to the “Payment info” subsection and includes interactive user interface component 703 labeled “Add info.” Similarly, some of the other subsections include their own respective interactive user interface component, such as buttons corresponding to functionality such as editing a subscription plan, changing the billing owner, and contacting support. Although other subsections may not necessarily include interactive buttons, they can be interactive subsections that are dynamically updated with content, such as the number of services enabled and/or active. As shown in FIG. 7, interactive user interface component 703 corresponds to a user interface component button that allows the client to add more information and edit information related to payment information. Interactive entity 701 also includes the description “No credit cards added” within its subsection. In various embodiments, the description is used at least as one input to determine synonyms and/or the context of interactive entity 701.

In various embodiments, interactive entity 701 is identified as the matching entity of content page 700 that is responsive to natural language input request 601 of FIG. 6. After being identified as a matching result, interactive user interface component 703 is modified as part of a guidance presentation to bring it to the attention of the client. For example, the background color of interactive user interface component 703 can be modified to allow it to stand out. As another example, interactive user interface component 703 can be flashed, highlighted, outlined, and/or animated. In various embodiments, one or more visual modifications are made to content page 700, interactive entity 701, and particularly to interactive user interface component 703 to highlight and/or focus the client's attention on interactive user interface component 703. The modification can include modifications to the presentation style of interactive user interface component 703 including changes to an associated style sheet and/or element. In various embodiments, the guidance provided provides the client with an indication that a matching entity within a content page has been identified.

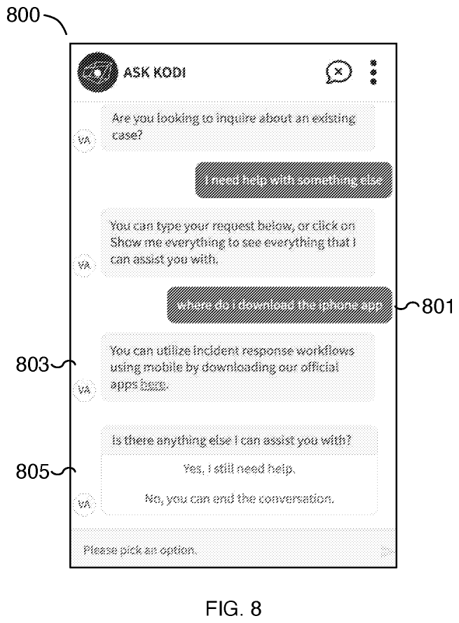

FIG. 8 is a diagram illustrating an embodiment of a virtual agent user interface for providing natural language input. The diagram of FIG. 8 provides another example in addition to the diagram of FIG. 6. Using the processes of FIGS. 2-5, a client is presented with virtual agent user interface 800 and in response to a provided natural language input client request, the client can be automatically guided to a content page and corresponding entity of the content page. In some embodiments, the virtual agent user interface is provided to a client by an application service utilizing an automatic guidance service. For example, the automatic guidance service implements the virtual agent as part of its automatic guidance service. In some embodiments, the automatic guidance service is automatic guidance service 125 of FIG. 1, the application platform hosting the application service is application platform 121 of FIG. 1, and the client is client 101 of FIG. 1.

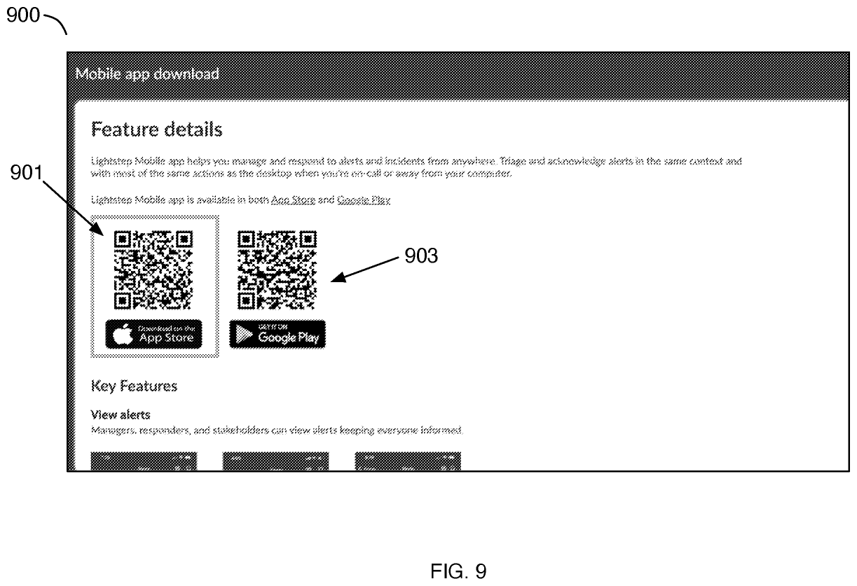

In the example shown, virtual agent user interface 800 is the user interface for a virtual agent. Using the virtual agent, a client can provide natural language input including requests for navigating the content pages of the application service. As shown in FIG. 8, virtual agent user interface 800 includes natural language input request 801 and automatic guidance service responses 803 and 805. Natural language input request 801 includes the request “where do i download the iphone app” as provided by the client without punctuation and capitalization. In response, the automatic guidance service automatically directs the client to the corresponding content page and entity within the content page that is hosted by the application service. In addition, the automatic guidance service provides two text-based responses via the virtual agent. Automatic guidance service response 803 includes the response “You can utilize incident response workflows using mobile by downloading our official apps here.” The last word “here” in the response includes a direct link to the identified content page. In various embodiments, the identified content page is shown in FIG. 9. Automatic guidance service response 805 is a follow up response that queries the client to determine whether the client needs additional assistance.

FIG. 9 is a diagram illustrating an embodiment of an example content page of an application service accessible via an automatic guidance service. Content page 900 is hosted by an application service and includes two subsections corresponding to interactive entities 901 and 903. In response to a natural language input client request shown in FIG. 8, the client is automatically directed and/or guided to the content page 900 and interactive entity 901 within content page 900. For example, interactive entity 901 of content page 900 can be highlighted and/or brought into focus for the client in response to the client's natural language input request. In some embodiments, the automatic guidance service is automatic guidance service 125 of FIG. 1, content page 900 is hosted on application platform 121 of FIG. 1, and the client is client 101 of FIG. 1.

In the example shown, content page 900 corresponds to the “Mobile app download” content page and includes interactive entities 901 and 903. Interactive entities 901 and 903 correspond to two different interactive download actions. Interactive entity 901 corresponds to an iOS or Apple App Store download action for the requested version of the app and interactive entity 903 corresponds to an Android or Google Play Store download action for a corresponding different version of the requested app. In some embodiments, the source code of content page 900 associates the <h1> (or heading 1) HTML tag (or another appropriate tag) with the “Mobile app download” heading and each of interactive entities 901 and 903 with the same tag as each other but different than the one for “Mobile app download.” For example, interactive entities 901 and 903 can each be associated with the same tag such as the <h2> HTML tag or another tag including a non-heading tag.

In various embodiments, interactive entity 901 is identified as the matching entity of content page 900 that is responsive to natural language input request 801 of FIG. 8. Interactive entity 901 is analyzed and a determination is made that it does not include any additional interactive user interface components such as buttons. Instead, interactive entity 901 itself functions as the primary interactive user interface component for the entity. After being identified as a matching result, interactive entity 901 is modified as part of a guidance presentation to bring it to the attention of the client. For example, the background color of interactive entity 901 can be modified to allow it to stand out. As another example, interactive entity 901 can be flashed, highlighted, outlined, and/or animated. In various embodiments, one or more visual modifications are made to content page 900 and particularly to interactive entity 901 to highlight and/or focus the client's attention on interactive entity 901. The modification can include modifications to the presentation style of interactive entity 901 including changes to an associated style sheet and/or element. In various embodiments, the guidance provided provides the client with an indication that a matching entity within a content page has been identified.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a natural language input;
providing the natural language input to a machine learning model to identify a content page associated with an intent of the natural language input;
dynamically analyzing the content page to determine interactive entities of the content page;
among the interactive entities of the content page, identifying a matching interactive entity corresponding to the natural language input; and
providing an indication of the matching interactive entity.

2. The method of claim 1, wherein identifying the matching interactive entity corresponding to the natural language input includes creating, for each of the interactive entities, a different entity context.

3. The method of claim 2, wherein creating, for each of the interactive entities, the different entity context includes identifying a corresponding set of one or more synonyms associated with a corresponding one of the interactive entities.

4. The method of claim 3, further comprising comparing the received natural language input to the different created entity context for each of the interactive entities.

5. The method of claim 1, further comprising:
configuring a mapping of potential intents to a plurality of content pages including the content page; and
training the machine learning model to predict the intent of the natural language input.

6. The method of claim 5, wherein providing the natural language input to the machine learning model to identify the content page associated with the intent of the natural language input includes predicting the intent of the natural language input and mapping the predicted intent to the content page using the mapping of the potential intents to the plurality of content pages.

7. The method of claim 1, wherein dynamically analyzing the content page to determine the interactive entities of the content page includes parsing the content page to identify markup language tags of the content page.

8. The method of claim 1, wherein dynamically analyzing the content page to determine the interactive entities of the content page includes identifying a corresponding document object model node of the content page associated with each of the interactive entities of the content page.

9. The method of claim 1, wherein providing the indication of the matching interactive entity includes modifying a visual presentation associated with the matching interactive entity.

10. The method of claim 9, wherein the visual presentation is associated with a cascading style sheet of the content page.

11. A system, comprising:
one or more processors; and
a memory coupled to the one or more processors, wherein the memory is configured to provide the one or more processors with instructions which when executed cause the one or more processors to:
receive a natural language input;
provide the natural language input to a machine learning model to identify a content page associated with an intent of the natural language input;
dynamically analyze the content page to determine interactive entities of the content page;
among the interactive entities of the content page, identify a matching interactive entity corresponding to the natural language input; and
provide an indication of the matching interactive entity.

12. The system of claim 11, wherein identifying the matching interactive entity corresponding to the natural language input includes creating, for each of the interactive entities, a different entity context.

13. The system of claim 12, wherein creating, for each of the interactive entities, the different entity context includes identifying a corresponding set of one or more synonyms associated with a corresponding one of the interactive entities.

14. The system of claim 13, wherein the memory is further configured to provide the one or more processors with the instructions which when executed cause the one or more processors to compare the received natural language input to the different created entity context for each of the interactive entities.

15. The system of claim 11, wherein the memory is further configured to provide the one or more processors with the instructions which when executed cause the one or more processors to:
configure a mapping of potential intents to a plurality of content pages including the content page; and
train the machine learning model to predict the intent of the natural language input.

16. The system of claim 15, wherein providing the natural language input to the machine learning model to identify the content page associated with the intent of the natural language input includes predicting the intent of the natural language input and mapping the predicted intent to the content page using the mapping of the potential intents to the plurality of content pages.

17. The system of claim 11, wherein dynamically analyzing the content page to determine the interactive entities of the content page includes parsing the content page to identify markup language tags of the content page.

18. The system of claim 11, wherein dynamically analyzing the content page to determine the interactive entities of the content page includes identifying a corresponding document object model node of the content page associated with each of the interactive entities of the content page.

19. The system of claim 11, wherein providing the indication of the matching interactive entity includes modifying a visual presentation associated with the matching interactive entity.

20. A computer program product, the computer program product being embodied in a non-transitory computer readable storage medium and comprising computer instructions for:
receiving a natural language input;
providing the natural language input to a machine learning model to identify a content page associated with an intent of the natural language input;
dynamically analyzing the content page to determine interactive entities of the content page;
among the interactive entities of the content page, identifying a matching interactive entity corresponding to the natural language input; and
providing an indication of the matching interactive entity.
